(19) United States
(12) Patent Application Publication
(10) Pub. No.: US 2013/0179041 A1
(43) Pub. Date: Jul. 11, 2013

(54) CRASH STRUCTURE FOR THE ABSORPTION OF CRASH ENERGY AND METHOD FOR ADJUSTING THE RIGIDITY OF A CRASH STRUCTURE

(71) Applicant: Stephan Loosen, Mundelsheim (DE)

(72) Inventor: Stephan Loosen, Mundelsheim (DE)

(21) Appl. No.: 13/808,811

(22) PCT Filed: May 12, 2011
(86) PCT No.: PCT/EP2011/057656

§ 371 Date: Mar. 25, 2013

(30) Foreign Application Priority Data
Jul. 7, 2010 (DE) 10 2010 031 032.8
Jul. 15, 2010 (DE) 10 2010 031 358.0

(51) Int. Cl. B60R 19/34

(52) U.S. Cl. CPC B60R 19/34
USPC 701/45; 293/133

(57) ABSTRACT

A crash structure for absorbing crash energy is provided for installation in a vehicle front, in which an actuating system is provided which sets a rigidity of the crash structure as a function of a signal characterizing a crash. Furthermore, the crash structure has a sensor system which outputs this signal. Moreover, the crash structure has two modules that are connected to each other, the connection breaking as of a predetermined force, so that then the at least two modules move with respect to each other, until at least one stop has been reached. The signal indicates the breaking and the reaching of the stop.

### FIELD

The present invention relates to a crash structure for the absorption of crash energy and a method for adjusting the rigidity of such a crash structure.

### BACKGROUND INFORMATION

A crash box is described in European Patent No. EP 1 792 786 A2, which has a housing-type deformation profile having a flange plate at the long channel bar end of the chassis frame, and is developed as a folded construction of sheet metal. The deformation profile is made up of two shell components, a flange plate section being attached to each shell component. The shell components are folded from initial mounting plates made of sheet metal, that are subsequently assembled and joined together using resistance welding points. This represents a usual crash box without any adaptation to a crash process. However, such an adaptation is described in German Patent No. DE 197 45 656 A1, for example. In that instance, a crash damper for a vehicle is described, a deformation being able to be controlled as a function of a precrash signal, that is, a signal of an allround view sensor system such as on a radar sensor system or a crash signal. On a deformation element, sliders move perpendicular to the direction of force and thereby block the deformation elements, so that because of the force effect, these deformation elements reduce the crash energy by the plastic deformation based on the blocking. An adaptation to the crash process is possible because of a parallel arrangement or by an interconstruction of such deformation elements. As a further example, a deformation element is used for the reduction of crash energy by tapering. In this instance, an element is fixed for tapering and an additional one is able to be released by a slider so as to reduce the tapering. The motion of the slider takes place in radial fashion, in this instance, i.e., perpendicular to the direction of force, and thus to the longitudinal axis of the deformation element, usually a cylinder having a specified wall thickness.

### SUMMARY

An example crash structure, according to the present invention, for the absorption of crash energy and an example method, according to the present invention, for adjusting the rigidity of such a crash structure may have the advantage that it is possible to distinguish between various severe vehicle collisions in time, for the purpose of adjusting the rigidity of the crash structure. However, the signal of the sensory system may also be used for this in order to actuate other retention devices, such as air bags or belt tensioners. Furthermore, an aim is being pursued of assuring both one's own protection and also car-to-car protection in the case of a collision and, at the same time, to save vehicle weight by the design of the crash structure, and thereby lower energy consumption. Because of the example crash structure according to the present invention and the example method according to the present invention, the security of the sensing by the sensing system and the speed of this sensing may be improved.

The example crash structure according to the present invention is located in the front region of the vehicle. This crash structure will experience a deformation immediately after contact with the other collision party. Depending upon the design, rapid sensing and actuation is required, preferably in the single-digit millisecond range. During the sensing and actuating, the actuating mechanism must not be stressed by crash forces. Making a rapid distinction of collision severities is certainly and reliably possible by using the example crash structure according to the present invention and the example method according to the present invention. In addition, it is achieved, using the present invention provided, that sensing and actuating are able to take place without the actuating mechanism being stressed ahead of time.

The crash structure is intended to replace a usual crash box and the front part of the elongated frame element. With that, the two functionalities of these elements, that are to be replaced, are mapped and at least two, later even more rigidities are able to be set. The basic setting of the crash structure is a higher rigidity, which normally corresponds to the rigidity of the front elongated frame element. However, other rigidity levels are optionally also possible, since the present invention is just as applicable to them. The decision as to whether a switchover of the rigidity takes place or not, is made by the severity of the accident it seeks to detect. For example, switching over from hard to soft in rigidity should take place at a speed of less than 16 km/h. However, this limit speed may be selected optionally. A distinction for additional rigidity settings, which the actuating mechanism undertakes, is possible anyway.

As described above, the crash structure is an element which is built in instead of the front part of the elongated frame element and the crash box. For this, this crash structure has the required interfaces for being reliably installed, for instance, by being screwed in or welded in. The crash structure is used for absorbing crash energy, that is, kinetic energy is transformed into deformation energy, and consequently absorbed. This protects the vehicle's occupants. Because of the place of installation, it is clear that the crash structure is installed in the front of the vehicle.

However, it is also possible to put the example crash structure according to the present invention in the rear-nd section.

Components of the crash structure are generally designated as modules that are connected to one another, the connection breaking as of a predetermined force, so that then the at least two modules move with respect to each other, until at least one stop has been reached. Normally, a module belonging to a current crash structure will stand still, and the other module will move to the stationary module. However, other configurations are also presently possible. The stop designates that a module, which usually moves, can then no longer move any more. Both the breaking and the stop lead to clearly perceivable signals, which may be easily recorded by a sensor system, such as an acceleration sensor system or a structure-borne noise sensor system.

The actuating system may carry out an adjustment in the rigidity of the crash structure as a function of the detected crash. The actuating system is driven electrically and in the case of a deformation by tapering is, for instance, able to change the degree of tapering. However, the actuating system is also able to change other types of deformation, that may be provided, respectively. A sensor system generates this signal that characterizes a crash. Because of the present invention, the signal has the information about the breaking and the stop. But the fact that the adjustment of the rigidity takes place as a function of this signal of the sensor system also means that an intermediate step is able to take place, namely, the processing of this signal in a control unit, for example, which is located inside or outside the crash structure. This processing, for example, retains the breaking and the reaching of the stop, and determines from them the speed of penetration. A possible setting of the rigidity may be determined with the aid of the speed of penetration.

The at least two modules may advantageously be situated in the front region of the crash structure. This means that, as a result of the crash, first the breaking of the connection between the at least two modules will take place and the the relative motion, until the stop has been reached. Only then is the crash structure deformed. The at least two modules should therefore be situated in the front region of the crash structure. In this context, a connection to the crossmember of the vehicle may be provided at the front of the vehicle.

The connection between the at least two modules is preferably developed with force-locking, that is, by screwing or riveting, for example. As a result of the relative motion, shearing forces may then develop that lead to the breaking of the connection. The predetermined force, as of which this breaking takes place, is in this case the lowest possible rigidity of the crash structure that is able to be set. With that, the crash structure according to the present invention preferably also fulfills the function of a crash box. For, the crash box is designed, with regard to its rigidity, in such a way that it is the lowest possible rigidity of the crash structure that is able to be set.

The first of the at least two modules is preferably a hollow section into which the second of the at least two modules penetrates. This second of the at least two modules has an adapter plate at the end facing away from the hollow section.

The second of the at least two modules, in this instance, is also preferably developed as a section shape, and designed as one piece with the adapter plate. A sensor system, such as an acceleration sensor system or a structure-borne noise sensor system may be mounted on the adapter plate, which outputs the signal that indicates the breaking and the reaching of the stop. The rigidity of the crash structure is then set as a function of this signal.

The signal is advantageously also used for the actuation of personal protective devices, such as air bags or belt tensioners. A message to the driver may also be output as a function of a signal. Such a message is, for instance, that the driver should check whether it is time for the exchange of the crash-active structure in a repair shop.

Exemplary embodiments of the present invention are described in greater detail in the description below, and shown in the figures.

### BRIEF DESCRIPTION OF THE DRAWINGS

FIG. 1 shows a vehicle front having a crash structure according to an example embodiment of the present invention.

FIG. 2 shows a first embodiment variant of the present invention.

FIG. 3 shows a signal curve.

FIG. 4 shows a second variant of the present invention.

FIG. 5 shows a third variant of the present invention.

FIG. 6 shows a fourth variant of the present invention.

FIG. 7 shows a fifth variant of the present invention.

FIG. 8 shows an example flow chart of the method according to the present invention.

### DETAILED DESCRIPTION OF EXAMPLE EMBODIMENTS

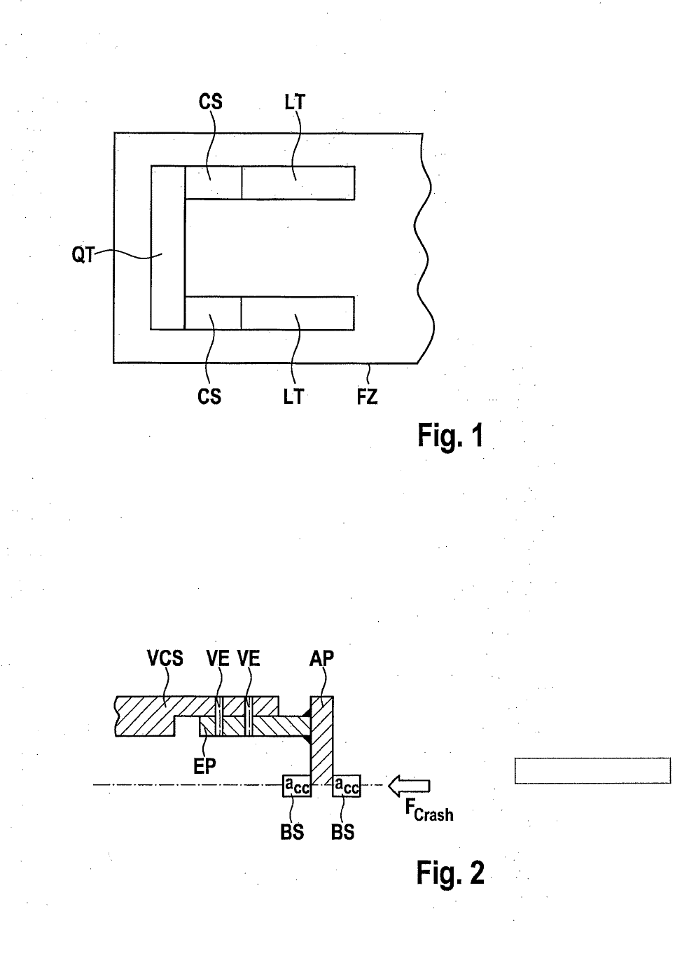

FIG. 1 shows a vehicle front of a vehicle FZ having a crossmember QT and a crash-active structure CS, which is situated between the crossmember and the respective elongated frame element LT. The task of crash structure CS is to absorb crash energy, when energy of motion is converted to energy of deformation. For this, the crash structure is provided with a rigidity that is adjustable. This rigidity is set as a function of a signal that is generated by a sensor, according to the, present invention, which measures, with the aid of its particular form, according to the present invention, the speed of penetration and consequently the collision speed. With that, the rigidity may then be set free of force.

The present invention provides that, in the front part of the crash structure a relative motion takes place between a first and a second module of the crash structure. These modules may be profiles, for example, the first module being a hollow section into which the second profile penetrates.

FIG. 2 shows relevant component parts. As the end of penetrating profile EP an adapter plate AP may be fastened for the fastening of additional components, as shown in the figure, or the crossmember may be fastened directly. Profile EP, for example, a tube and adapter plate AP may be produced from plentiful resources, that is, as one piece or joined, as shown in FIG. 2, such as welded, for example. Penetrating profile EP is connected via connection elements VE to front crash structure VCS. This connection may be force-locking, for instance by screws or rivets, but other methods are also possible. Connection elements VE represent a predetermined breaking point during a collision. As of a specified force, which is at the level of the lower rigidity of the crash structure, for instance, at the crash box level, these elements VE have to fail. For this, see also the direction by F crash. Only this assures that, even in the case of a light crash, that is at the absorption level of a crashbox, there will be a sensing of the collision severity, since for that the breaking of the connection elements, such as bolts VE, is required. These bolts VE must not be dimensioned to be too weak, since otherwise even at lighter collisions, that are below the effective range of the crahsbox, the breaking of the bolts occurs and thus repair of the structure would be required without the inter-penetrating profiles of the structure having experienced any relative motion at all.

However, it is also possible, even though not shown in FIG. 2, that profile VCS of the front crash structure lies inside and the penetrating profile is guided outside on the crash structure. What is important is that when one displaces the tubes EP and VCS with respect to each other, there is a fixed stop.

For the sensing of the severity of the accident, an acceleration sensor is used. It is applied onto the adapter plate, optionally inside or outside. FIG. 2 shows both mounting possibilities, but what is actually used is only one sensor per crash structure and thus per vehicle side.

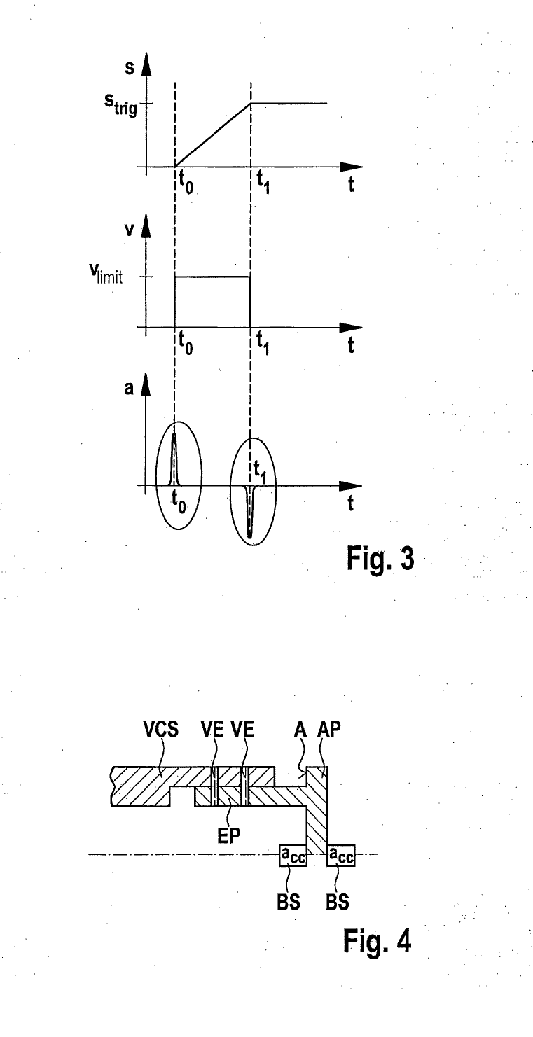

The collision force is transmitted via the vehicle front to the adapter plate and penetrating profile EP. The connection elements are thereby stressed to shearing. At the breaking of connection elements VE, a relative motion takes place between the component parts shown. The breaking loose becomes visible in the signal of acceleration sensor ES as a pronounced peak. There will be a second peak when the adjustment element hits a stop at tapering tube VCS. The peaks are shown in simplified form in FIG. 3, and they are circled in the lower acceleration/time diagram. Respective times t₀ or t₁ characterize the time in which the modules according to the present invention have moved with respect to each other. In the upper two diagrams, the latter is shown as a path and also as a speed.

t₀:: the breaking of the bolt leads to a peak in the signal of the acceleration sensor.

t₁:: the stop of the adjustment element on the tapering tube leads to the peak in the signal of the acceleration sensor.

The time between the two peaks is measured. The relative motion that the two components are able to execute is known. Consequently it may be calculated how high the penetration speed is and with that, how high the collision speed is. With the aid of this speed it may be decided whether a switchover in the rigidity of the crash structure should be undertaken or not.

$${v}_{rel} = \frac{{S}_{trig}}{{t}_{sens}}$$

With tₛₑₙₛ=t₁ t₀: time between the pronounced peaks in the acceleration signal.

S_{trig}: path which the two components were able to cover with respect to each other.

Vᵣₑₗ: Relative speed among the components.

For this, the equation is transposed for the sensing time, and as speed the speed is used as of which switching over to the soft rigidity is to take place (vₗᵢₘᵢₜ):

$${t}_{limit} = \frac{{S}_{trig}}{{v}_{limit}}$$

where

s_{trig}: path which the two components were able to cover with respect to each other.

vₗᵢₘᵢₜ. relative speed below which switching over the rigidity should take place.

tₗᵢₘᵢₜ: time at the limiting speed between the two peaks.

One may see from the equation that, at a collision speed which is below the speed vₗᵢₘᵢₜ, the time t_{Limit} is exceeded. This is drawn upon as a triggering criterion for switching over to the lower rigidity of the crash structure. s_{trig} and v_{Limit} are to be selected, in this context, in such a way, that the time required for an unstressed actuation of the actuation system remains.

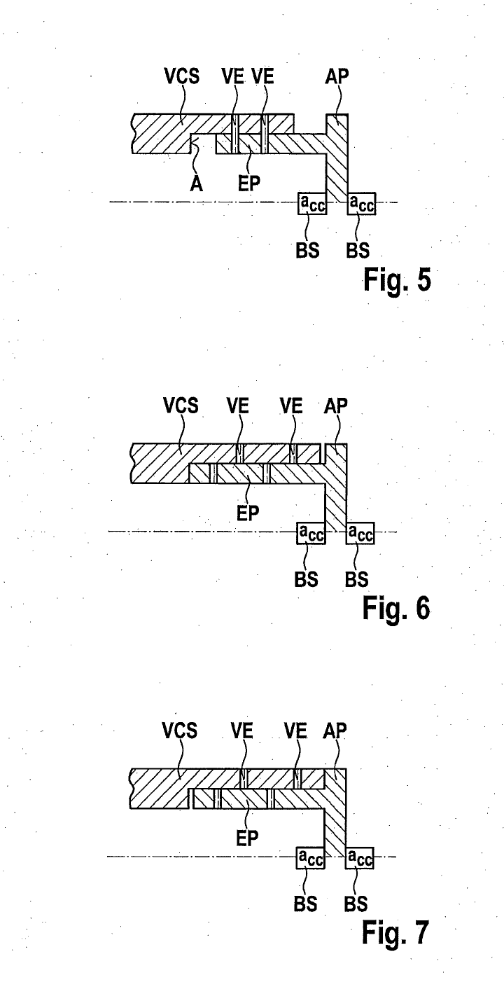

The stop of the penetrating profile into the profile of front crash structure VCS may be positioned either inside or outside, as is shown in FIGS. 4 and 5. The stop is designated by A, in this case, and the remaining elements are designated by the same reference characters. Whether the stop is inside or outside is decided by the requirements of the installation. The stop lying inside has the advantage that, in the case of welding, for example, of the adapter plate to penetrating profile EP, the bead of the welding seam does not interfere with the stop. In the case of screwing in the longitudinal direction, this problem, for example, would not occur. For the sensing, the two variants are equivalent.

In FIGS. 2 and the following, two connection elements are shown in the longitudinal direction. In principle, however, the number may be made up of one or several elements. From the sectional images shown, one may see two connection elements over the circumference of the profiles. In this case, too, one or more connection elements may be distributed over the circumference. The dimensioning of the elements takes place accordingly.

The connection elements shown have the advantage that the structures ahead of the crash structure, e.g., a mounted crossmember including assemblies, is fixed in the longitudinal direction on the front part of the crash structure. The connection elements shown are a simple implementation of this fixing.

Because of the pronounced acceleration peaks in response to the breaking of the connection elements, it may in addition be determined that stressing of the structure, at least to the crashbox level, has taken place and that the crash structure has undergone a deformation. This has the advantage that the driver, who is not able to estimate with certainty the actual severity and the requirement of a repair station visit, is able to be encouraged by a message to have his car examined. This may be done via the internal infotainment system, for example.

The acceleration sensors used, in combination with the mounting, may have the advantage that they are able to supply data beyond the decision on switching the adaptive crash structure, which data may be drawn upon in triggering devices of restraint. This applies to parameters such as time, force, but also for offset crashes or slantwise impacts. An upfront sensor system, conditioned by the place where it is installed, is only able to supply a signal for a few milliseconds. After that, place of installation and/or the sensor system have been destroyed by deformation conditioned upon the collision, and they no longer supply any reliable signals. Above all, when mounted inside, the sensor system is protected from this according to the present invention.

Besides integration into automatic control devices, such as ESP and air bag control units, the data may also be integrated into a combined control unit of air bag with driving dynamics functions and evaluated. These are also able to undertake the actuation of the actuating system or may even generate signals and instructions which are transmitted via a bus system to other control units, which then undertake the activation of the actuating system. It is also possible that the data be sent to a control unit, via a bus system such as a CAN bus, in which the conditioning as well as the processing of the data take place in an algorithm. This may be the air bag control unit, for example.

FIGS. 6 and 7 show the respective structure having an inner and an outer stop in the engaged state, i.e., the stop has been reached.

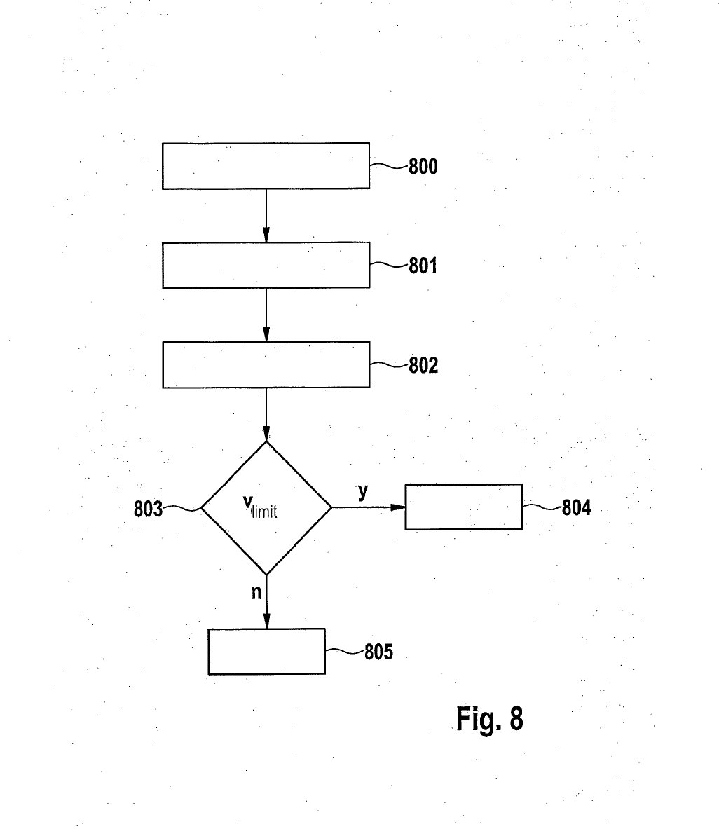

FIG. 8 shows a flow diagram of the example method according to the present invention. In method step 800, the sensor signal is generated when the two modules move with respect to each other and the stop has been reached. In method step 801, the analysis of this sensor signal takes place for signal features which characterize the breaking and the stop. From that, in method step 802, the penetration speed is determined. In method step 803, it is determined whether the penetration speed is less than a specified limit speed v_{Limit}. If this is the case, in method step 804, the adjustment of the rigidity takes place, for, if in the initial state the rigidity is set high, but the limit speed is low, the rigidity has to be lowered to a softer crash. In addition, a warning to the driver may be output. If, however, the speed is greater than v_{Limit} in method step 803, in method step 805, no change in rigidity is undertaken, since now one may expect a hard crash.

1-12. (canceled)

13. A crash structure for absorbing crash energy for installation in a vehicle front, comprising:
at least two modules which are connected to each other, the connection configured to break as of a predetermined force, so that the at least two modules are able to move with respect to each other, until at least one stop has been reached.

14. The crash structure as recited in claim 13, wherein the at least two modules are situated in the front region of the crash structure.

15. The crash structure as recited in claim 13, wherein the connection is a force-locking connection.

16. The crash structure as recited in claim 13, wherein the predetermined force is a lowest rigidity of the crash structure that is able to be set.

17. The crash structure as recited in claim 13, wherein a first one of the at least two modules is a hollow section into which a second one of the at least two modules penetrates.

18. The crash structure as recited in claim 17, wherein the second one of the at least two modules has an adapter plate at an end facing away from the hollow section.

19. The crash structure as recited in claim 18, wherein the second one of the at least two modules has a section shape and is one piece with the adapter plate.

20. The crash structure as recited in claim 19, wherein a sensor system is mounted on the adapter plate which is configured to output a signal that indicates the breaking and the reaching of the stop, and wherein the rigidity of the crash structure is set as a function of the signal.

21. A crash structure for absorbing crash energy for installation into a vehicle front, comprising:
an actuating system which sets a rigidity of the crash structure as a function of a signal characterizing a crash;
a sensor system which outputs the signal; and
at least two modules which are connected to each other, the connection configured to break as of a predetermined force, so that the at least two modules are able to move with respect to each other, until at least one stop has been reached, wherein the signal indicates the breaking and the reaching of the stop.

22. A method for setting a rigidity of a crash structure which is used for absorbing crash energy, comprising:
setting the rigidity as a function of a signal characterizing a crash, the signal being provided by a sensor system, wherein the signal indicates a breaking of a connection of at least two modules and a reaching of a stop after a relative motion of the at least two modules.

23. The method as recited in claim 22, wherein the signal is also used by an actuator of retention devices.

24. The method as recited in claim 22, further comprising:
outputting a message to a driver as a function of the signal.
